(19) United States
(12) Patent Application Publication
(10) Pub. No.: US 2008/0120380 A1
(43) Pub. Date: May 22, 2008

(54) INTERNET RELAY CHAT (IRC) FRAMEWORK FOR A GLOBAL ENTERPRISE SERVICE BUS (ESB)

(75) Inventors: Erin Ann Boyd, Manhattan, MT (US); Stewart Jason Hyman, Richmond Hill (CA); James T. Smith, Boulder, CO (US); Stephen James Watt, Cedar Park, TX (US)

Correspondence Address: RICHARD M. GOLDMAN, 371 ELAN VILLAGE LANE, SUITE 208, SAN JOSE, CA, 95134, US

(73) Assignee: International Business Machines Corporation, Armonk, NY (US)

(21) Appl. No.: 11/560,877

(22) Filed: Nov. 17, 2006

(51) Int. Cl. G06F 15/16

(52) U.S. Cl. 709/206

(57) ABSTRACT

An enterprise service bus (ESB) having a plurality of internet relay chat (IRC) clients and internet relay chat (IRC) ‘bots’ that provide ESB like routing and mediation functionality. The internet relay chat (IRC) framework provides messaging transport, and utilizes SOA specific tooling to turn IRC into an SOA framework.

### BACKGROUND

1. Field of the Invention

The invention described herein relates to enterprise scale enterprise service busses (ESB) comprising a plurality of internet relay chat (IRC) links.

2. Background Art

Enterprise service busses (ESB) provide, inter alia, message transformation and message routing. An enterprise service bus connects a service requestor, a service that offers a publish operation, and a service provider, e.g. a service provider that offers a notify operation. A role of the enterprise service bus is to resolve mismatches, e.g., mismatches between what the service requester wants and what the actual service provider can give. Specifically, the ESB performs the necessary message transformation so that the service requester can successfully communicate with the service provider.

Current ESB solutions require large initial investments due to the cost of proprietary ESB products, the complexity and size of the of the ESB network itself, and the extensive Service Oriented Architecture (SOA) and product specific expertise necessary to create global ESB networks. But the reality is that it would be desirable to leverage existing networks to implement ESB's on an enterprise or global scale. This would save on initial investment, allow enterprises to leverage existing knowledge and skills through an incremental addition of technology to add “ESB” functionality to existing communications mechanisms, and leverage the global or enterprise reach of existing networks if one was available.

As used herein Service Oriented Architecture (“SOA”) generally means the underlying structure supporting communications between services. In this context, a service is defined as a unit of work to be performed on behalf of some computing entity, such as a human user or another program. In this context “SOA” defines how two computing entities, such as programs, interact in such a way as to enable one entity to perform a unit of work on behalf of another entity. Service interactions are defined using a description language. Each interaction is self-contained and loosely coupled, so that each interaction is independent of any other interaction.

Service Oriented Architectures generally have protocol independence. That is, the protocol independence of SOA means that different consumers can use services by communicating with the service in different ways. Typically this is through a management layer between the providers and consumers to ensure complete flexibility regarding implementation protocols.

A secondary concern that must be addressed is that without prolific adoption of ESB integration capabilities to enable global Service Oriented Architecture (SOA) consumption of services across enterprise boundaries, contemporary visions of on demand will be very difficult to realize. For this reason a new approach to ESB is needed, one that does not use proprietary software or require expensive upgrades to implement. The ideal solution would be one that leverages existing integration networks, within enterprises and hopefully on a global scale as well across the internet, with little to no initial investment. The small investment to large return would make this solution, if it were to exist, a more realistic approach to SOA integration across enterprise boundaries.

Individual ESB technologies and services do exist that allow enterprises to create their own instance of an ESB, but none of these address the larger issue of global interoperability in a consistent manner requiring minimal initial investment.

Business to Business (“B2B”) Gateways that can use ESB technology as their foundation. These gateways are intended to provide local integration between paying applications, however they are managed by the central ESB service provider rather then the customer, allowing the specific technology choice for ESB to be abstracted away from the customer through a technology outsourcing paradigm, but not really changing the paradigm of the ESB network itself.

ESB products of the prior art all have drawbacks. Many prior art ESB products are intended to be used in a closed ESB instance, designed to integrate within its own instance alone. The technology choice might provide for some external integration capabilities (web services gateways, etc) but the main intention of the ESB application is not to provide strong management mechanisms for those external integrations, but rather to more effectively manage the internal enterprise integrations within the domain of the single ESB.

Business to Business (B2B) integration services do not change this paradigmatic drawback, they just change the business model.

No Global ESB networks exist, and none of the ESB solutions on the market today provide for leverage of any existing communications tooling as part of the core ESB itself. There is no “integrated” view of ESB alongside the other communications mechanisms that would be used within an enterprise.

Thus a clear need exists for an enterprise service bus system (ESB) that provide ESB like routing and mediation functionality, using, for example, a plurality of internet relay chat (IRC) clients and internet relay chat (IRC) ‘bots,’ to provide ESB functions such as messaging transport.

### SUMMARY

Described herein is an enterprise service bus system (ESB) comprised of a plurality of internet relay chat (IRC) clients and internet relay chat (IRC) ‘bots.’ The internet relay chat (IRC) clients and internet relay chat (IRC) ‘bots’ provide ESB like routing and mediation functionality. Specifically the enterprise service bus system (ESB) includes an internet relay chat (IRC) framework that provides messaging transport, and utilizes SOA specific tooling that turns the IRC's into an SOA framework.

The enterprise service bus comprising an internet relay chat (IRC) instant messaging network having one or more internet relay chat (IRC) servers as a set of internet relay chat (IRC) bots to integrate and mediate between an applications interface and the internet relay chat (IRC) network may by adapted for use as an Application Integration Broker.

The enterprise bus provides “request/reply” application messaging, “publish/subscribe” application messaging, network persistence, durability, mediation, translation, transformation, message processing rules, services registry, and internet relay chat (IRC) network bridging. The enterprise service bus may provide instant messaging and may be used to integrate new applications.

IRC is a chat system developed in 1988 and described in http://www.irc.org/history_docs/jarkko.html. IRC's have been in widespread use across the internet and within enterprises for many years. The IRC chat system allows for pub/sub communications, point to point, synchronous or asynchronous messaging, broadcasting, and also provides for relay network redundancy and high availability with extremely high performance and scalability, and already has clearly defined RFC's for server-side protocols, client-side protocols, channel management (pub/sub topic management), and architecture. IRC RFC's can be found at http://www.irc.org/techie.html.

As described herein, the invention leverages existing Internet Relay Chat (IRC) networks within enterprises and across the Internet as the transport mechanism for a global integration infrastructure, or ESB. By creating a lightweight set of Service Oriented Architecture (SOA) robots (IRC “Bots”) that provide ESB capabilities for service registration and mediation, as well as a lightweight IRC ESB client that application owners can use to connect their applications to the IRC ESB, the enterprise and global IRC networks provide a solution to the problem described above.

The invention described herein is a global ESB solution designed to provide global integration between applications and enterprises, rather then merely a product or services sales opportunity. The invention described herein allows multiple enterprises to leverage intranet and internet IRC networks to seamlessly integrate internal and external applications in a manner that no single product solution could otherwise provide.

The initial investment of this solution is much smaller then the investment required for any alternative product approach, since no new network application would need to be purchased, learned, and implemented. Rather the centralized ESB capabilities are plugged into any existing IRC network to convert the IRC into an ESB and all the other messaging characteristics of IRC could be preserved to reduce the investment required to enable SOA within or across enterprise boundaries.

### THE FIGURES

FIG. 1 illustrates ESB Mediation of Point to Point Services on IRC transport

FIG. 2 illustrates ESB Mediation of Pub/Sub Services on IRC transport

FIG. 3 illustrates a high level flow chart of the method of the invention of creating and operating an enterprise service bus system adapted, for example, for instant messaging and for integrating new applications.

### DETAILED DESCRIPTION

The invention relates to the creation of new IRC clients and IRC ‘bots’ that provide ESB like routing and mediation functionality. The IRC framework itself is providing the messaging transport, but utilizes Service Oriented Architecture (SOA) specific tooling that is created by the IRC integration to turn IRC into a Service Oriented Architecture (SOA) framework.

Generally, a person would use an interactive client like MIRC to connect to an IRC server that has been deployed as part of an existing network of IRC servers. The user could then use this client to message with any other user on IRC so long as the that target user is active, the messaging mechanism being used has security settings that allow for the message to happen, and the target user is willing to accept the message once it gets to him/her.

For a point to point message, a user can type “/msg <TargetUserName> <text message to send>” and hit enter. The IRC client packages the /msg command into IRC defined MSG format, and relays the message to the IRC server it is connected to. The IRC network then relays that message from server to server until it reaches the target user according to the relay and routing algorithms built into IRC. If the receiving client has not set any specific filtering security to ignore or otherwise handle messages from the sending client, then the message is delivered and displayed on the receiving client for the viewing by the destination user.

IRC has a native pub/sub mechanism called “IRC channels”, which are basically chat rooms that any client may join. If a client joins a chat room that does not yet exist, then the chat room is created dynamically in the IRC network and other users may join that channel to begin messaging. If any one user sends a message into the channel, then it is publishes automatically to all other subscribers. In this way, multiple people can chat at once, with a record of the entire discussion showing similarly on each users client interface.

If a user joins a chat room that does not yet exist, then the chat room is created dynamically in the IRC network and the user that created the channel is given default “operator” status in the channel. Operators may modify the behavior settings for the channel, or bestow operator status on other users who subsequently subscribe to the same channel. Some IRC key channel operator capabilities include, by way of exemplification:
1) Setting a password required to join the channel.
2) Setting the channel to “invite only”, meaning an explicit invitation must be extended by an operator in the channel to a user before that user is allowed to join.
3) Permitting some people to talk, while preventing others from talking. This setting is called “voice” permission, and the default is to not enforce voice permissions, allowing anyone to talk if they desire.
4) Kicking users from the channel, and/or ban them from rejoining the channel.
5) Setting a topic for the channel.

If an operator leaves the channel then their operator status is lost and must be bestowed back upon them by another operator once they rejoin.

IRC has a clearly defined set of triggers that go off inside IRC clients whenever a particular event happens. That is, a message has been sent, a message has been received, a user has joined channel, etc. are all examples of triggers that can be programmed for automated responses. Most IRC clients provide native scripting languages that let a user program automated responses to triggers, or a user can develop an entirely new IRC client that connects to IRC server ports directly and acts as a wholly automated robot, also known as an IRC “Bot”. Bots are commonplace across IRC and are often used to help protect operator status in channels or provide some other helper service on the network. Many bots have an interface for configuration, outside of IRC.

A bot is a client. On a basic level, a bot is just a program that simulates an IRC client, listening for messages and chat it recognizes, performs functions and sending messages to users. Seager's bot consists of two classes:

The base class |BasicIRCBot| is a framework bot that can log on to a server, remain connected, and listen for private messages.

The executable bot class |Testbot| extends |BasicIRCBot| and adds some logic for dealing with specific messages.

The IRC protocol uses plain text, formatted into various messages to handle actions such as logins, messages, actions, and notifications. The exact format of, say, a logon message is spelt out in the RFC.

The class |BasicIRCBot| handles the logon to an IRC server, setting up its nickname and description, listening for private messages, and handling other IRC-specific messages.

The actual runnable class, |Testbot|, extends |BasicIRCBot| and overrides the |srv_privmsgs| method, which is called with the contents of a private message and the name of the user who sent it. This method details how the bot decides to act on a message sent from an IRC user. The |main| method of |Testbot| instantiates itself, connects the bot to a server, and sends it into a loop that listens for messages and handles them.

The |BasicIRCBot| class constructor takes two |String|s—the bot's nickname and description. After the class is instantiated, its |connect| method is called, passing the hostname and port of the IRC server as parameters. The bot opens a simple socket to the server and gets an output and input stream to send and receive messages to the server. This is mere sockets code and nothing IRC-specific has happened yet.

Logging on—The next thing the bot does is log on to the IRC server in its |logon| method. This method sends the IRC logon message |user Testbot ware2 irc: Test bot|. The message tells the server that the bot's local username is “Testbot,” its host is “ware2,” and its description is “Test bot.”

The next message sent to the server is |nick Testbot|, which requests the nickname Testbot for the bot. An IRC nickname is how a user is seen on the IRC network. It's used when another user wants to talk privately (with a series of private messages) and is typically known as a user's /nick/ in IRC lingo.

These two messages are the minimum that should be sent to an IRC server to log on. At this point, the server will log on the bot and send back a few welcome messages (containing the server's message of the day and server stats). Now the bot is logged on to the server and can be examined from another IRC client using the command |/whois Testbot|.

The Testbot program next enters a loop calling the |service| method repeatedly until its |running| variable becomes |false|. It then logs out of the server and ends. The |service| method of |BasicIRCBot| is its core—this method listens for messages sent from the IRC server, determines the type of message, and takes the appropriate action.

As a general rule all communications in IRC are routed through the server. If a user wants to send you a message, they send it to the server, which then relays it to you (the “R” in “IRC”). While there are many different types of messages in IRC, the |BasicIRCBot| deals only with two: pings and private messages.

To ensure that clients are still connected, an IRC server will periodically send them a ping message. This message takes the form |ping [number]| (for example, |ping 10023|). To indicate they are still there, clients respond with the message |pong [number]| (in this case, |pong 10023|). Failure to respond to a ping message quickly enough will result in the server disconnecting a user (or /kicking/ them). This timeout value is a server-specific setting. Typical values are around a minute or so.

Ping handling occurs in the private |pingpong| method, which returns |true| if the server message was a ping and prints |ping pong| to |System.out|. Leave the bot idle and connected and watch its console output to see how often a server sends ping messages.

Most IRC messages take the form |:<prefix> <command> <parameters>|, so the |BasicIRCBot| |service| method splits the message into those three strings. The |<command>| is a string that indicates what is happening; for instance, a private message command is |privmsg|. The |service| method checks for this specific command string. If the message isn't a |privmsg|, the method sleeps for a tenth of a second and returns.

The meaning of the prefix portion of a message depends on the command. For a |privmsg|, the prefix contains the nickname, username, and host of the IRC user who sent the message (generally in the format |<nickname>!=<username>@<hostname>|, but possibly in the format |<nickname>|). The code extracts and passes the nickname and parameters to the |BasicIRCBot| private method |parse_privmsg| for further processing.

A |privmsg| parameter contains the nick of the user the message is for (in this case, the bot's nick) and the message, coded in the format |<nick>:<message>| or |<nick> <message>|. The |parse_privmsg| extracts the nick and message and calls the protected method |srv_privmsg| to act upon the message.

In the |BasicIRCBot| class, this method is empty. We override it in the |Testbot| class to respond to a few different messages from a user. This technique allows us to extend the |BasicIRCBot| to handle messages from users.

The |BasicIRCBot|:

Lurks on a server until it's told to quit or is kicked off

Responds to certain messages, providing a useful time service

Can be extended to join channels, respond to more messages, or perform any number of useful functions using the RFC as a guide.

If a robot is supposed to automatically join channel X, and provide operator status to user Y whenever he joins, then there are 3 ways this can be configured into the robot:
1) hard code this logic into the code of the robot itself,
2) provide in-band automation that allow the robot to be configured form within IRC by sending it private messages, or
3) provide an out-of-band web interface for configuring the robot.

To ensure that all messaging destinations are unique, IRC enforces the use of unique nicknames, however IRC historically has not enforced authentication of clients that select the nicknames in question. More recent IRC servers do have integrated services for password authentication of clients to nicknames, and this service must in fact be provided through the IRC servers to ensure security. When a client connects to an IRC server with the authentication service enabled, the server must prevent any messages to/from that client until they have in fact been authenticated. If this is not enforced within the IRC network itself then any client could temporarily spoof as any nickname until that client gets killed from the IRC network (for lack of proper authentication) by a robot with IRC operator status. Even this type of short lived spoofing is unacceptable, so server-side authentication would be required for IRC to act as an ESB where the IRC network prevents any communication to/from the client until proper authentication has been received.

IRC is a messaging framework that has grown as a party line for people to chat with one another rather then an enterprise application integration framework. In order for IRC to provide the higher order autonomic integration capabilities of an ESB, additional clients and robot tooling would need to be created to fill the gaps between standard IRC messaging and the robust messaging of an ESB. The invention herein focuses on the nature and substance of these IRC clients and robots, in order to demonstrate how they synergistically interact to work in order to enable IRC as a viable ESB transport mechanism. This is done without modification to any existing IRC clients, since these are designed for person to person communication rather then application to application. The invention described herein also does not require modification to any existing IRC servers, since the biggest advantage that IRC has to offer is its globally deployed infrastructure. If redeployment of IRC servers would be required to turn IRC into an ESB, then the benefit and savings of this approach would be nullified.

In a Services Oriented Architecture (SOA) it is common practice for service providers to register the services they can provide, and for consumers to look up those services in order to determine what they need or want to consume, and also how to consume it (for example, protocol, location/address, payload format, etc.).

IRC does not provide any such services registry natively, so this type of registry would need to be provided as a centralized service, in the form of an SOA Services Registry Robot. The robot would need to allow service providers to register details about the service they are providing, and explicitly provide details about the nature of the messaging type required for the service. The services registry robot should also integrate into an external SOA Services Portal that allows for services searching and registration through the web.

In the case of pub/sub services registration, it is the job of the services registry robot to spawn a unique channel for the service as services registration time and leave a drone or channel operator active in that channel at all times. That robot will be responsible, as a services registry operator, maintain operator status in the channel and to handle the provision of voice status to subscribers as necessary on channel join. In most cases the service provider will be the only subscriber in the channel that requires voice permission, which in this context means permission to publish messages. All service consumers need the ability to join the channel and to listen but will not likely need the ability to publish messages themselves since the publish capability is a function of the service being provided, rather then the consumer of that service.

It is important for pub/sub services to understand the difference between being subscribed to a service and being subscribed to a channel. A service consumer may join a service channel if subscribed to the service, meaning channel access is guarded by invitation only to prevent non-subscribed users from gaining access to a subscription channel. Managing access by invitation should be the responsibility of the services registry robot drone that gets spawned into the channel. It's also important to understand that a service consumer could be subscribed to a service but be offline and therefore not currently subscribed to a channel.

Translation and mediation are key functionalities of an ESB but are often misunderstood. Translation usually means translation between various data formats and protocols, while mediation usually means mediation between differing business processes. Translation is usually considered to be much easier since it's often just an exercise of performing an ETL (extract, transform, and load) of data from one side of the communication to the other. Mediation is much more difficult due to the subjective interpretation of a business process on either side of a transaction. To make this clearer, it's easier to translate one data field format to another, but it's much more difficult to understand what each party intends to use that field for within their business process or within their applications that manage that business process.

IRC does not provide native mechanisms for either mediation or translation, since it was inherently designed to allow communication between humans. In order to extend an IRC network to become an ESB, we introduce mediation capabilities in the form of a centralized “mediation robot” that could act as an automated mediation proxy between communicating parties.

Regardless of whether services are point-to-point or pub-sub in nature, a service mediation robot should be spawned by the service-consumer to handle mediation and translation for each service consumer. A single service mediation robot is sufficient per IRC client, since that robot can be used to mediate between the client and all services it consumes. In the case of the Point to Point (P2P) service the mediation robot handles all communication between the service consumer IRC client and the service provider IRC client, whereas in the case of a pub/sub service the mediation robot handles all communication between the service consumer IRC client and the service provider IRC channel that is used for publishing messages.

One advantage of the architectures and protocols described herein is that protocol mediation is generally never required on this IRC framework since everyone would be using the same protocol to communicate. The mediation robots would only ever provide business process mediation and data translation. Configuration of mediation robots (creation of data mapping files, etc.) is handled through the SOA web portal.

Message persistence is the storing of service messages to disk until they have been received successfully by all intended recipients. The goal of persistence is to provide recovery capabilities should the ESB system crash, so that on restart the messages could still be delivered since they were persisted before the failure. Message durability is the storing of transient service messages (not necessarily to disk) while intended recipients are offline, so that the message can be delivered at some future time when the recipient comes back online. For example, a service consumer might send a service request to a service provider, and then promptly crash. The service provider receives the service request properly, processes the request and then wants to send the response back to the original service requester, however that requester is offline. The ESB infrastructure is supposed to provide message durability to alleviate the burden of keeping that service response in memory from the service provider. Instead, the service provider sends the service response as if the requester was online, and a proxy service in the ESB stores that message until the service requestor comes back online, and deliver the message at that time.

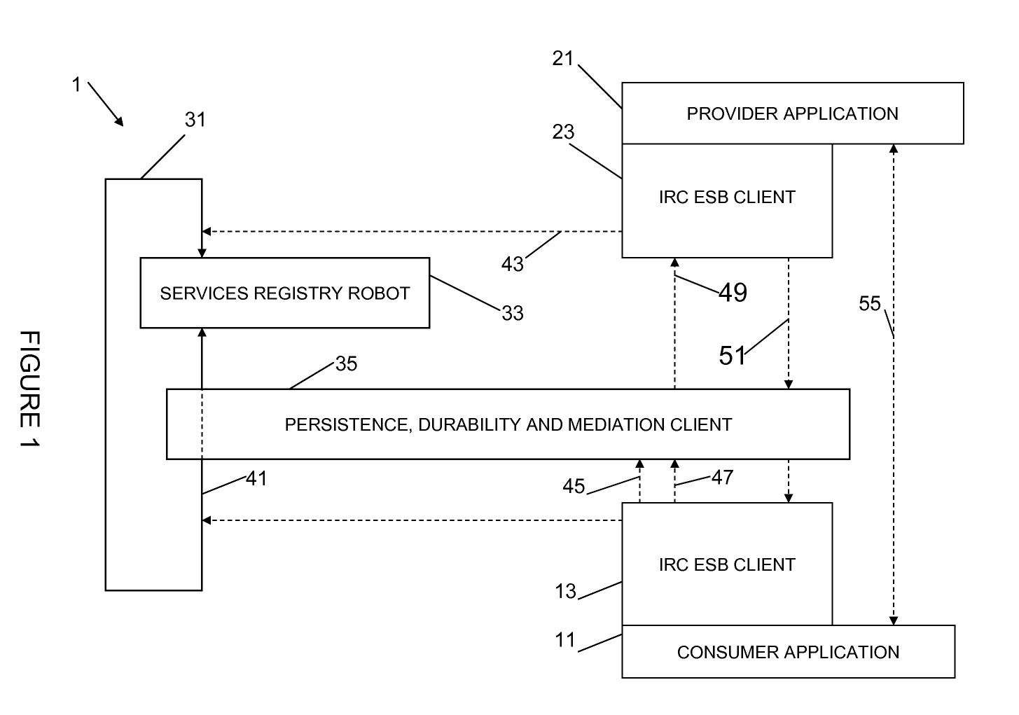

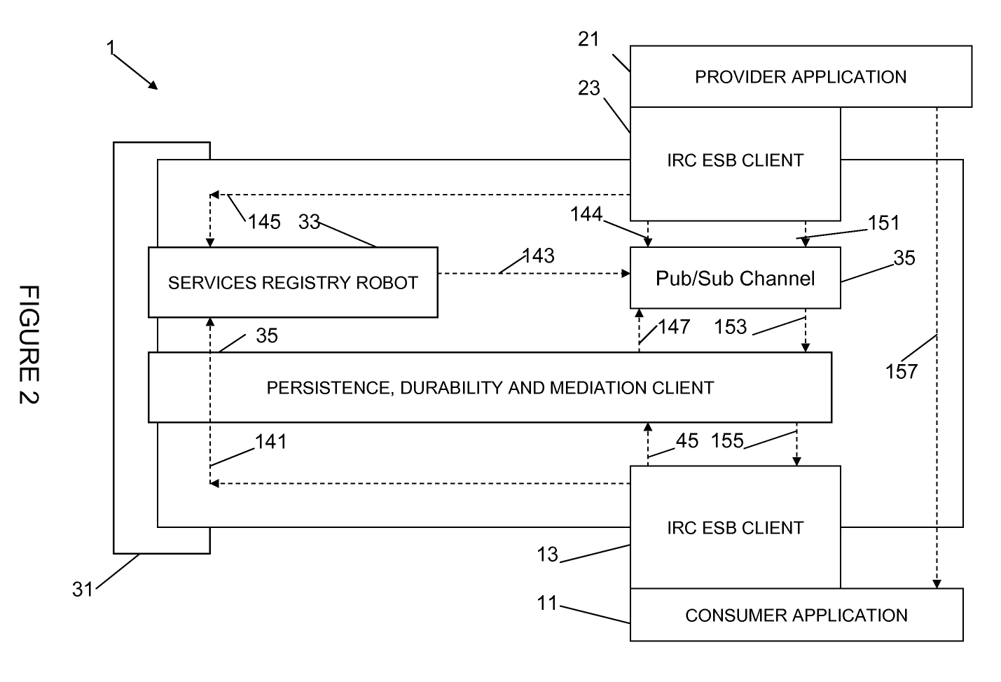

Both message persistence and durability need to be provided within the path of messages between service consumers and service providers. FIG. 1 and FIG. 2 show persistence and durability being provided by the same robot that provides mediation. This means the robot is responsible for storing the message to disk when it receives the messages to or from the service consumers. In the case of pub/sub services these capabilities might rather be split out of this consumer-side robot into a centralized persistence and durability robot that provides this capability per service channel. Either is fine, although the latter approach may provide greater stability and performance since there are less moving parts and each message only needs to be stored to disk a single time. Settings for durability and persistence should be configurable out-of-band through the SOA web portal.

FIG. 1 illustrates ESB Mediation of Point to Point Services on IRC transport. Illustrated is an Enterprise Service Bus connecting a consumer application 11 and a first IRC ESB Client 13 to a Provider Application 21 and a second IRC ESB Client 23 at a SOA Web Portal 31, and including a Services Registry Robot 33 and a Persistence, Durability and Mediation Robot 35.

The first IRC ESB Client 13 looks up a P2P Service Definition 41 on the Services Registry Robot 33 where the second IRC ESB Client 23 has registered a P2P service. The first IRC ESB Client 13 spawns a mediator 45 and issues a service request to the persistence, durability, and mediation robot 35. The persistence, durability, and mediation robot 35 sends a mediated service request 49 to the second IRC ESB Client 23 which issues an asynchronous request 51 to the persistence, durability and mediation robot 35.The persistence, durability and mediation robot 35 sends a mediated service request 53 to the first IRC ESB Client 13.

The result is an ESB mediation of point to point services through the IRC bots, 13, 23, 33, and 35, between the consumer application 11 and provider application 21, resulting in a logical message flow 55 between the consumer application 11 and the provider application 21.

FIG. 2 illustrates ESB Mediation of Pub/Sub Services on IRC transport. Illustrated is an Enterprise Service Bus connecting a consumer application 11 and a first IRC ESB Client 13 to a Provider Application 21 and a second IRC ESB Client 23 at a SOA Web Portal 31, and including a Services Registry Robot 33 and a Persistence, Durability and Mediation Robot 35.

The first IRC ESB Client 13 looks up a pub/sub Service Definition 141 on the Services Registry Robot 33 where the second IRC ESB Client 23 has registered a Pub/Sub service 145. The first IRC ESB Client 13 spawns a (subscribe) mediator 45 to the persistence, durability, and mediation robot 35. The persistence, durability, and mediation robot 35 sends a join channel as listener request 147 to the Pub/Sub channel 35. The second IRC ESB Client 23 which issues a request to the Pub/Sub Channel 35 to join the channel as a publisher 149 and publish a message 151. The Pub/Sub Channel 35 issues a deliver published message command 153 to the persistence, durability, and mediation robot 35. The persistence, durability and mediation robot 35 sends a deliver mediated message request 155 to the first IRC ESB Client 13.

The result illustrated in FIG. 2 is ESB mediation of Pub/Sub services on IRC transport.

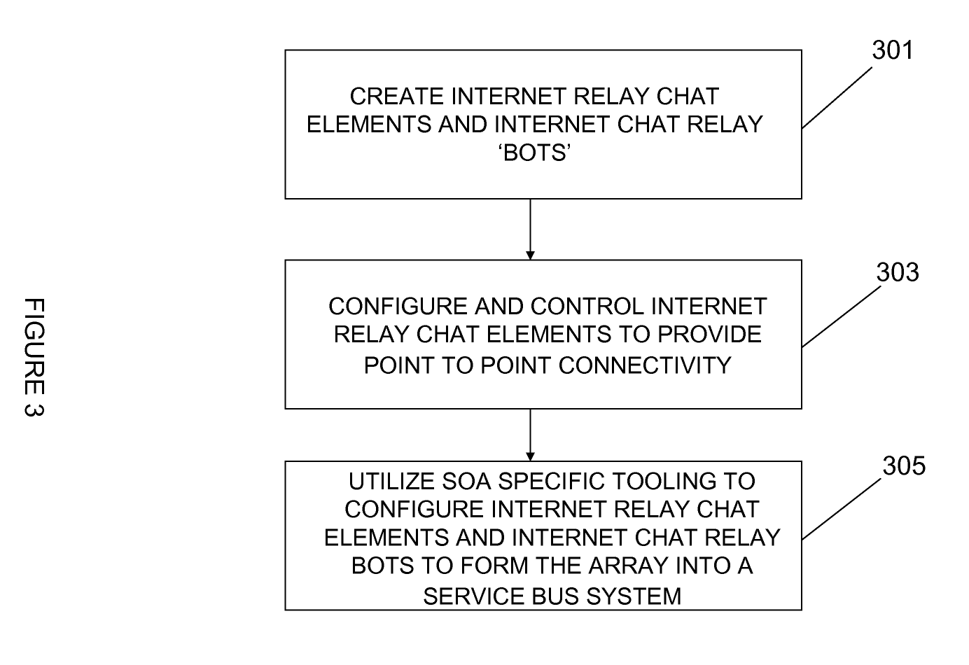

FIG. 3 illustrates a high level flow chart of the method of the invention of creating and operating an enterprise service bus system adapted, for example, for instant messaging and for integrating new applications.

A first step is creating a network or array of internet relay chat elements and internet chat relay ‘bots’, 301. The next step is configuring and controlling the internet relay chat elements to provide point to point connectivity, 303. The method then utilizes SOA specific tooling to configure the internet relay chat elements and internet chat relay bots to form the array into a service bus system 305. This allows turning the internet relay chat elements into an SOA framework and providing messaging transport to provide ESB like routing and mediation functionality.

In a further exemplification the internet relay chat elements are configured and controlled to form an internet relay chat element instant messaging network that is adapted for use as an Application Integration Broker. This network has one or more internet relay chat element servers as a set of internet relay chat (IRC) bots adapted to integrate and mediate between an applications interface and the internet relay chat (IRC) network.

A further exemplification is configuring and controlling the internet relay chat elements to provide point to point connectivity to publish subscription application messaging, network persistence, durability, mediation, translation, transformation, message processing rules, services registry, and internet relay chat element(IRC) network bridging.

The invention may be implemented, for example, by having enterprise service, including the system for managing the enterprise service bus as a program product. This is accomplished by executing the various internet relay chats making up the enterprise service bus method as a software application, in a dedicated processor or processors, or in a dedicated processor or processors with dedicated code. The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for performing the enterprise service bus and internet relay chat and internet relay chat bots as a software application or set of integrated software applications.

This signal-bearing medium may comprise, for example, memory in a server. The memory in the server may be non-volatile storage, a data disc, or even memory on a vendor server for downloading to one or more processors for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable code, script code and wizards for installation, as in Zip code and cab code. As used herein the term machine-readable instructions or code residing in or on signal-bearing media include all of the above means of delivery.

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

We claim:

1. An enterprise service bus (ESB) system for connecting a provider application and a consumer application, the system comprising a plurality of internet relay chat (IRC) clients and internet relay chat (IRC) ‘bots’, said IRC ‘bot’ clients comprising SOA specific tooling to provide an SOA framework comprising said internet relay chat (IRC) ‘bots’ and providing messaging transport, ESB system like routing and mediation functionality.

2. An enterprise service bus (ESB) system comprising an internet relay chat (IRC) instant messaging network adapted for use as an Application Integration Broker, having one or more internet relay chat (IRC) servers and a set of internet relay chat (IRC) bots adapted to integrate and mediate between an application interface and the internet relay chat (IRC) network.

3. The enterprise service bus system of claim 2, said enterprise service bus system adapted to provide point to point connectivity to publish subscription application messaging, network persistence, durability, mediation, translation, transformation, message processing rules, services registry, and internet relay chat (IRC) network bridging.

4. The enterprise service bus system of claim 2 adapted for use for instant messaging and for integrating new applications thereto.

5. A program product comprising a computer readable media having computer readable program code thereon, said program code adapted to configure and control a plurality of internet relay chat (IRC) clients and internet relay chat (IRC) ‘bots’ arrayed in an enterprise service bus system (ESB) comprising a plurality of the internet relay chat (IRC) clients and internet relay chat (IRC) ‘bots’ that utilize SOA specific tooling to array the internet relay chat clients into an SOA framework to provide messaging transport, ESB system like routing, and mediation functionality.

6. The program product of claim 5 adapted to configure and control the internet relay chat clients to form an internet relay chat (IRC) client instant messaging network adapted for use as an Application Integration Broker, having one or more internet relay chat (IRC) client servers as a set of internet relay chat (IRC) bots adapted to integrate and mediate between an applications interface and the internet relay chat (IRC) network.

7. The program product of claim 6 wherein said program product causes said enterprise service bus system adapted to provide point to point connectivity to publish subscription application messaging, network persistence, durability, mediation, translation, transformation, message processing rules, services registry, and internet relay chat (IRC) network bridging.

8. A method of creating and operating an enterprise service bus system adapted for use for instant messaging and for integrating new applications thereto comprising creating a plurality of internet relay chat elements and internet chat relay ‘bots’ therefore and configuring said internet relay chat elements and internet chat relay bots into an enterprise service bus system that utilizes SOA specific tooling to turn the internet relay chat elements into an SOA framework and provide messaging transport.

9. The method of claim 8 comprising configuring and controlling a plurality of internet relay chat (IRC) elements and internet relay chat (IRC) ‘bots,’ arrayed as an enterprise service bus (ESB) system comprising a plurality of the internet relay chat (IRC) clients and internet relay chat (IRC) ‘bots’, to provide ESB like routing and mediation functionality.

10. The method of claim 9 comprising configuring and controlling the Internet Relay Chat elements to provide messaging transport and an SOA network utilizing SOA specific tooling to turn the Internet Relay Chat elements into the SOA framework.

11. The method of claim 9 comprising configuring and controlling the internet relay chat elements to form an internet relay chat element instant messaging network adapted for use as an Application Integration Broker, having one or more internet relay chat element servers as a set of internet relay chat (IRC) bots adapted to integrate and mediate between an applications interface and the internet relay chat (IRC) network.

12. The method of claim 11 comprising configuring and controlling said internet relay chat elements to provide point to point connectivity to publish subscription application messaging, network persistence, durability, mediation, translation, transformation, message processing rules, services registry, and internet relay chat element(IRC) network bridging.
